(19) United States
(12) Patent Application Publication
(10) Pub. No.: US 2009/0070574 A1
(43) Pub. Date: Mar. 12, 2009

(54) Remote diagnostic apparatus

(76) Inventors: Michael A. Rothman, Puyallup, WA (US); Vincent J. Zimmer, Federal Way, WA (US)

Correspondence Address: Kraguljac & Kalnay, LLC, C/O INTELLEVATE LLC, P.O BOX 52050, MINNEAPOLIS, MN, 55402, US

(21) Appl. No.: 11/899,516

(22) Filed: Sep. 6, 2007

(51) Int. Cl. G06F 15/177

(52) U.S. Cl. 713/2

(57) ABSTRACT

Example apparatus and methods associated with remote diagnostics are described. One apparatus embodiment includes a logic to determine a state of a device associated with a computing platform to which the apparatus is operably connected. The apparatus embodiment may include logic to provide a signal to a remote logic regardless of the state of the computing platform. The apparatus embodiment may also include logic to receive a signal from a remote logic regardless of the state of the computing platform. The apparatus may facilitate actions associated with remote diagnostics including, inventorying add-on devices, controlling add-on device diagnostic execution, and selectively configuring the computing platform based on add-on device diagnostic results.

### TECHNICAL FIELD

Embodiments of the invention relate to the field of remote diagnostics. More particularly, at least one embodiment of the invention relates to an apparatus for booting up a platform in a platform safe mode with conditional initialization of an add-on device.

### BACKGROUND

Users sometimes unwittingly attach incompatible add-on devices to their computing platforms. Typically, shipped platforms have a known-good list of add-on devices that have been tested to ensure compatibility. This list is not comprehensive and often only includes add-ons shipped with the platform. Occasionally a user may plug an untested and/or incompatible add-on device into their platform. The add-on may not fully comply with certain standards. This may cause unexpected results resulting in breakdowns ranging from minor and occasional malfunctions to complete and immediate system failures.

The conventional diagnosis procedure for these breakdowns requires a user or technician to reset the malfunctioning system to “default settings” or going into an operating system “safe-mode”, which more often than not alleviates the problem but also greatly limits the capabilities of the platform. If the user is unable to determine the cause of failure, the next step is typically to contact the customer support of the manufacturer. This occasionally results in a local technician being sent to repair the malfunctioning system in person. This is expensive and undesirable.

### BRIEF DESCRIPTION OF THE DRAWINGS

The accompanying drawings, which are incorporated in and constitute a part of the specification, illustrate various example systems, methods, and other embodiments of various aspects of the invention. It will be appreciated that the illustrated element boundaries (e.g., boxes, groups of boxes, or other shapes) in the figures represent one example of the boundaries. One of ordinary skill in the art will appreciate that in some embodiments one element may be designed as multiple elements, multiple elements may be designed as one element, an element shown as an internal component of another element may be implemented as an external component and vice versa, and so on. Furthermore, elements may not be drawn to scale.

FIG. 1 illustrates an apparatus having at least some aspects of at least one embodiment of the invention.

FIG. 2 illustrates a platform having at least some aspects of at least one embodiment of the invention.

FIG. 3 illustrates a method for facilitating remote diagnostics in accordance with at least some aspects of the invention.

FIG. 4 illustrates a method for facilitating remote diagnostics in accordance with at least some aspects of the invention.

### DETAILED DESCRIPTION

User installed devices are one of the most common causes of platform instability. Being able to fall back to a configuration that can eliminate devices that create instability affects perceived RAS (reliability, availability, serviceability). Thus, example apparatus and methods facilitate remote diagnosis and/or repair of issues associated with misbehaving add-on hardware. An example apparatus may triage and remedy initialization failures caused by incompatible add-on hardware. In one example, an apparatus may acquire a clear inventory of devices being initialized, run diagnostics on devices on a per device basis, and then selectively disable devices or make a device(s) ineligible for initialization based on the results of the diagnostics. The apparatus may be part of a manageability engine.

One embodiment of the invention provides an apparatus for providing remote diagnostics for a computing platform. In one embodiment, the remote diagnostics apparatus may receive a signal from a remote logic independent of platform availability. This may enable diagnostics and repairs to be performed even if the platform is powered down or otherwise inoperable as the apparatus may operate with an alternate power source and an operable connection to the remote logic.

In one embodiment, the remote diagnostics apparatus may provide a signal to the remote logic independent of platform availability. This may allow the remote logic to diagnose problems associated with add-on devices operably connected to the platform and recommend courses of action that an internal logic or local user may take. This may reduce the number of situations where an expert is required to physically visit the platform in order to complete repairs.

The following includes definitions of selected terms employed herein. The definitions include various examples and/or forms of components that fall within the scope of a term and that may be used for implementation. The examples are not intended to be limiting.

“Data store”, as used herein, refers to a physical and/or logical entity that can store data. A data store may be, for example, a database, a table, a file, a list, a queue, a heap, a memory, a register, a disk, and so on. In different examples a data store may reside in one logical and/or physical entity and/or may be distributed between multiple logical and/or physical entities.

“Logic”, as used herein, includes but is not limited to hardware, firmware, software in execution and/or combinations thereof to perform a function(s) or an action(s), and/or to cause a function or action from another logic, method, and/or system. Logic may include a software controlled microprocessor, discrete logic (e.g., application specific integrated circuit (ASIC)), an analog circuit, a digital circuit, a programmed logic device, a memory device containing instructions, and so on. Logic may include a gate(s), a combinations of gates, other circuit components, and so on.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control.

“Signal”, as used herein, includes but is not limited to, electrical signals, optical signals, analog signals, digital signals, data, computer instructions, processor instructions, messages, a bit, a bit stream, or other means that can be received, transmitted and/or detected.

Some portions of the detailed descriptions that follow are presented in terms of algorithm descriptions and representations of operations on electrical and/or magnetic signals capable of being stored, transferred, combined, compared, and otherwise manipulated in hardware. These are used by those skilled in the art to convey the substance of their work to others. An algorithm is here, and generally, conceived to be a sequence of operations that produce a result. The operations may include physical manipulations of physical quantities. The manipulations may produce a transitory physical change like that in an electromagnetic transmission signal.

It has proven convenient at times, principally for reasons of common usage, to refer to these electrical and/or magnetic signals as bits, values, elements, symbols, characters, terms, numbers, and so on. These and similar terms are associated with appropriate physical quantities and are merely convenient labels applied to these quantities. Unless specifically stated otherwise, it is appreciated that throughout the description, terms including processing, computing, calculating, determining, displaying, automatically performing an action, and so on, refer to actions and processes of a computer system, logic, processor, or similar electronic device that manipulates and transforms data represented as physical (electric, electronic, magnetic) quantities.

It should be noted that references to an “always available network connection” and an “always available power source” and an “always available memory” do not mean literally “always available”. It is practically impossible to ensure that a machine has power or a network connection always available. Even if there are several backups and redundant systems, it is still not always possible to ensure the availability of power. Therefore, when references are made to an “always available” resource, it is implied that “always available” means “always available within practical limits.”

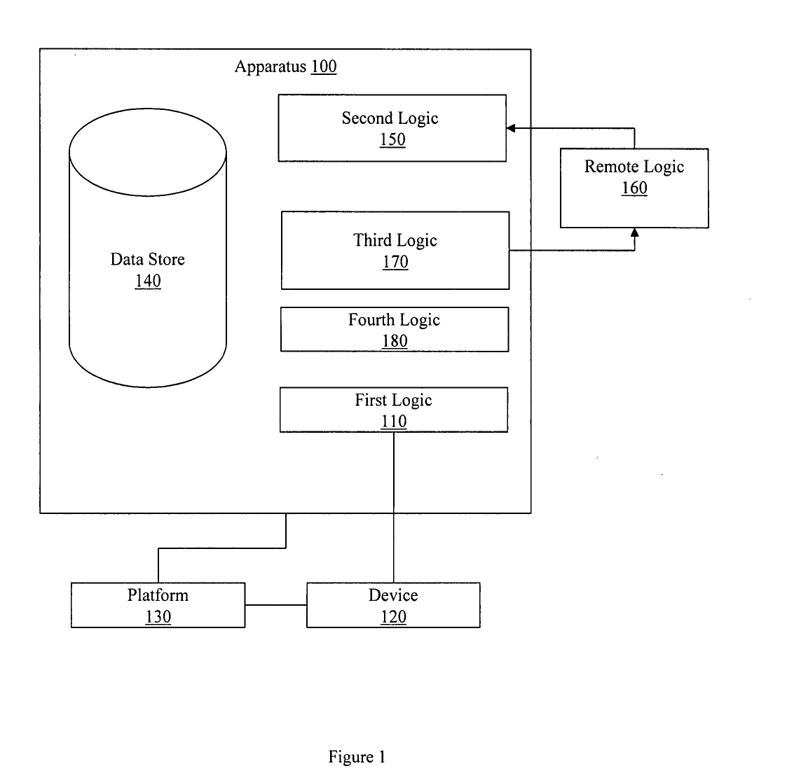

FIG. 1 illustrates an apparatus 100. Apparatus 100 facilitates performing remote diagnostics. Apparatus 100 may contain a first logic 110 to determine a state of a device 120 associated with a platform 130 to which apparatus 100 may be operably connected. Apparatus 100 may facilitate remote control over device 120. Apparatus 100 may also contain a data store 140. Data store 140 may store information concerning devices associated with platform 130. The information may include the state(s) of a device(s). Apparatus 100 may also include a second logic 150 to receive an incoming signal from a remote logic 160. The incoming signal may be configured to control apparatus 100. Apparatus 100 may also include a third logic 170 to provide an outgoing signal to remote logic 160. The outgoing signal may be configured to provide data from data store 140. Apparatus 100 may also include a fourth logic 180 to selectively control the operation of platform 130. This control may be based, at least in part, on information in data store 140, on a signal from remote logic 160, and so on.

Apparatus 100 may provide a signal to remote logic 160 independent of platform 130 availability. This may allow platform 130 or device 120 malfunctions to be diagnosed while the platform 130 is powered down. Signals provided to remote logic 160 may include an inventory of add-on devices operably connected to the platform 130, information concerning an add-on device 120 operably connected to the platform 130 including state information, information concerning the platform 130 status, information concerning an action initiated with respect to add-on devices, information concerning actions initiated with respect to the platform 130, and so on. Apparatus 100 may receive a signal(s) from the remote logic 160 independent of platform 130 availability. This may allow control of apparatus 100 while the platform 130 is powered down. This may allow platform 130 or device 120 malfunctions to be repaired while the platform 130 is powered down.

Apparatus 100 may also facilitate remote control over platform 130 and device 120. Remote control may include initiating a device self diagnostic to determine the state of the device. Device self diagnostics may be stored in an option ROM (Read Only Memory) associated with the device. Remote control may also include initiating a platform safe mode. Initiating a platform safe mode may include booting the platform 130 where devices not included in a known-good list are disabled, booting the platform 130 with operating system settings based on information in the data store 140, and booting the platform 130 with operating system settings based on a signal from the remote logic 160. These different boot modes facilitate conditional initialization of add-on devices. Remote control may also include selectively disabling a device 120 based on information in the data store 140 and selectively disabling a device 120 based on a signal from the remote logic 160. Remote control may also include booting the platform 130 in a desired state (e.g., platform safe mode). Booting the platform 130 may include selectively initializing an add-on device 120 operably connected to the platform 130, where the initializing may be based, at least in part, on information communicated to the platform 130 by the apparatus 100.

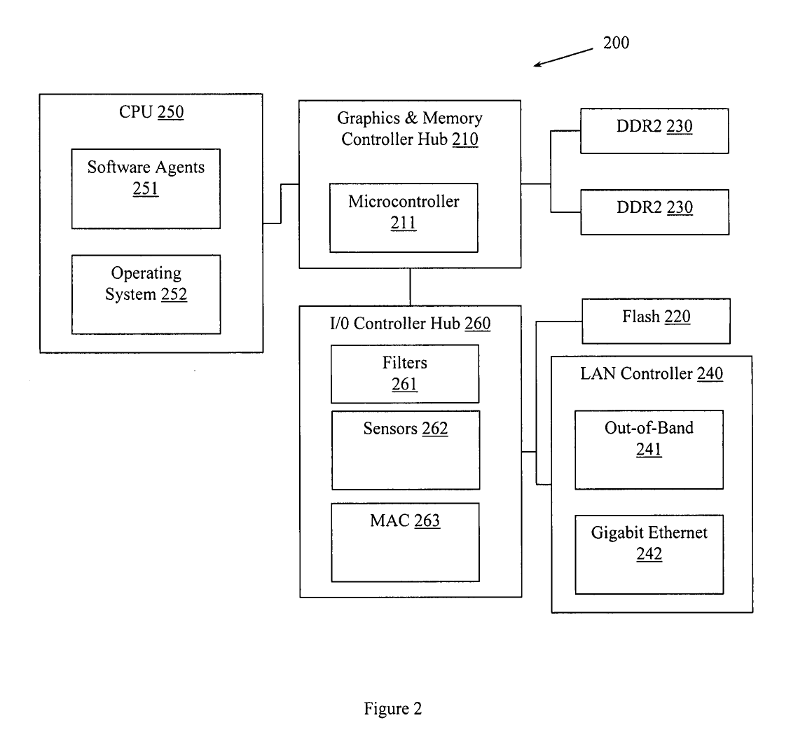

FIG. 2 illustrates a platform 200. Platform 200 may include a set of operably connected chips and/or chipsets. The platform 200 may include a graphics and memory controller hub chip and/or chipset 210. The graphics and controller memory hub 210 may include a microcontroller 211. One embodiment of apparatus 100 (FIG. 1) may reside in a manageability engine logic associated with microcontroller 211. In different examples, the first logic 110, the second logic 150, the third logic 170, and/or the fourth logic 180 may reside in microcontroller 211.

Platform 200 may also include a flash memory 220. Various elements of apparatus 100 (FIG. 1) may reside in flash memory 220. These elements may include the data store 140. Platform 200 may also include a Double Data Rate Random Access Memory (DDRAM) chip 230. While a DDRAM chip is illustrated, it is to be appreciated that in different examples other memory may be employed. Platform 200 may also include a LAN (Local Area Network) controller chipset 240. LAN controller chipset 240 may include an out-of-band connection 241 and a gigabit ethernet connection 242. Elements of apparatus 100 (FIG. 1) may be operably connected to connection 241 and/or connection 242. These elements may include the remote logic 160. Connection 241 and connection 242 may be always available network connections. These connections may allow microcontroller 211 to communicate with remote logics while platform 200 is powered down. Platform 200 may also include CPU (Central Processing Unit) 250. CPU 250 may include software agents 251 and/or operating system 252.

Platform 200 may also include an I/O (input/output) Controller Hub chipset 260. Chipset 260 may include filter chips 261, sensor chips, 262, and a Media Access Control (MAC) chip 263. These chips may allow platform 200 to communicate with an add-on device(s). These add-on devices may be operably connected to platform 200 by a peripheral component interconnect (PCI) connection, an accelerated graphics port (AGP) connection, a PCI-express (PCI-E) connection, a video graphics array (VGA) connection, a digital visual interface (DVI) connection, a universal serial bus (USB) connection, and so on.

Example methods may be better appreciated with reference to flow diagrams. While for purposes of simplicity of explanation, the illustrated methods are shown and described as a series of blocks, it is to be appreciated that the methods are not limited by the order of the blocks, as in different embodiments some blocks may occur in different orders and/or concurrently with other blocks from that shown and described. Moreover, less than all the illustrated blocks may be required to implement an example method. In some examples, blocks may be combined, separated into multiple components, may employ additional, not illustrated blocks, and so on. In some examples, blocks may be implemented in logic. In other examples, processing blocks may represent functions and/or actions performed by functionally equivalent circuits (e.g., an analog circuit, a digital signal processor circuit, an application specific integrated circuit (ASIC)), or other logic device. Blocks may represent executable instructions that cause a computer, processor, and/or logic device to respond, to perform an action(s), to change states, and/or to make decisions. While the figures illustrate various actions occurring in serial, it is to be appreciated that in some examples various actions could occur concurrently, substantially in parallel, and/or at substantially different points in time.

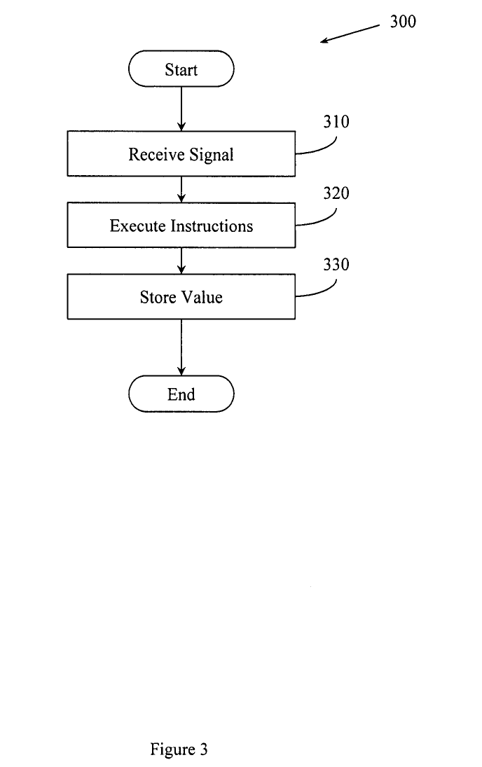

FIG. 3 illustrates a method 300. Method 300 may include receiving a control signal from a remote logic in a microcontroller at 310. The control signal may control execution of executable instructions stored in firmware in the microcontroller. The microcontroller may be a member of a chipset for a computing platform. The microcontroller may be operably connected to an always-on power supply and to an always-available memory.

Method 300 may also include selectively executing an executable instruction at 320. Which instruction(s) are executed at 320 may depend, at least in part on the control signal received at 310. Executable instructions may perform actions including establishing a platform safe mode for the computing platform, determining a state of an add-on device operably connected to the computing platform, communicating a conditional device initialization signal to the computing platform, instructing an add-on device operably connected to the computing platform to perform a diagnostic, and so on. Method 300 may also include storing a value in the always-available memory at 330. The value may be associated with the execution of the executable instructions at 320.

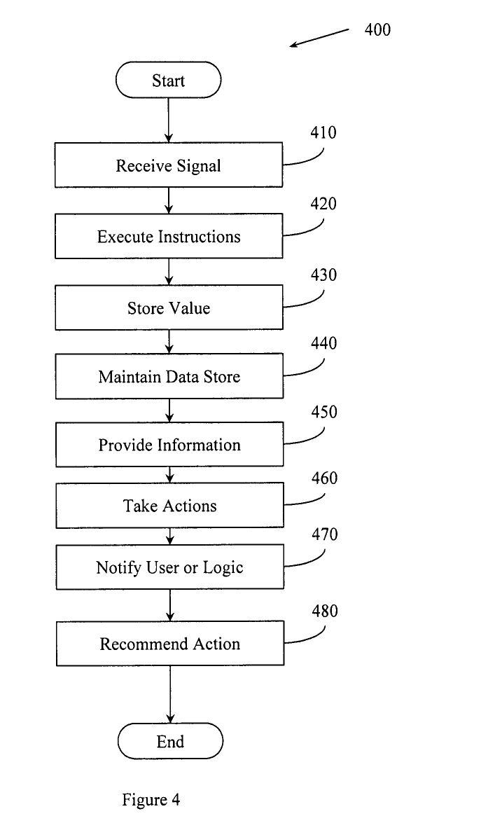

FIG. 4 illustrates a method 400. Method 400 includes some actions similar to those described in connection with method 300 (FIG. 3). For example, method 400 may include receiving a control signal at 410 and executing an executable instruction at 420. Additionally, method 400 may include storing a value in always-available memory at 430. The value may be related to an add-on device, a diagnostic result(s) associated with the add-on device, a boot configuration control signal associated with an add-on device, and so on.

Method 400 may also include additional actions. For example, method 400 may include maintaining a data store at 440. The data store may contain information regarding an add-on device operably connected to the computing platform. The information may include state information concerning a device(s). Method 400 may also include providing information from the data store at 450. Information may be provided to entities including a remote user, a local user, a remote logic, a local logic, and so on. Method 400 may also include taking actions based on information provided by the data store at 460. Method 400 may also include notifying a user or logic of information in the data store at 470. The user or logic may include, for example, a remote user, a local user, a remote logic, a local logic, and so on. Method 400 may also include recommending a course of action at 480 to the remote user, the local user, the remote logic, the local logic, and so on. The action to take may be based, at least in part, on information from the data store.

The action to take may include, for example, controlling a computing platform to acquire an inventory of add-on devices, selectively controlling an add-on device to perform a diagnostic, and configuring the computing platform so that certain add-on devices will not be initialized during a subsequent boot of the computing platform. These actions facilitate remotely diagnosing errors and producing a platform safe boot mode.

What is claimed is:

1. An apparatus, comprising:
a first logic to determine a state of a device associated with a computing platform to which the apparatus is operably connected and for which the apparatus facilitates remote control;
a data store to store information concerning the device, the information including the state of the device;
a second logic to receive an incoming signal from a remote logic, the incoming signal being configured to control the apparatus, the incoming signal being receivable by the second logic independent of computing platform availability;
a third logic to provide an outgoing signal to the remote logic, the outgoing signal being configured to provide diagnostic related data, the outgoing signal being provided independent of computing platform availability; and
a fourth logic to selectively control operation of the computing platform based, at least in part, on diagnostic related data associated with the device and a signal from the remote logic.

2. The apparatus of claim 1, where remote control provided by the apparatus includes one or more of, initiating a device self diagnostic to determine the state of the device, initiating a platform safe mode, selectively disabling a device based on information in the data store, selectively disabling a device based on a signal from the remote logic, and booting the computing platform.

3. The apparatus of claim 2, where the device self diagnostic resides in an option ROM (Read Only Memory) associated with the device.

4. The apparatus of claim 2, where initiating a platform safe mode includes one or more of, booting the computing platform where devices not included in a known-good list are disabled, booting the computing platform with operating system settings based on information in the data store, and booting the computing platform with operating system settings based on a signal from the remote logic.

5. The apparatus of claim 2, the device being an add-on device, and where booting the computing platform includes selectively initializing the add-on device based, at least in part, on information communicated to the computing platform by the apparatus.

6. The apparatus of claim 5, where the add-on device is operably connected to the computing platform by one of, a peripheral component interconnect (PCI) connection, an accelerated graphics port (AGP) connection, a PCI-express (PCI-e) connection, a video graphics array (VGA) connection, a digital visual interface (DVI) connection, and a universal serial bus (USB) connection.

7. The apparatus of claim 1, the apparatus being operably connected to an always available network connection and an always available power source.

8. The apparatus of claim 1, the data store being a flash memory.

9. The apparatus of claim 1, where at least one of, the first logic, the second logic, the third logic, or the fourth logic, reside in a manageability engine logic in a microcontroller, the microcontroller being a member of a platform chipset.

10. The apparatus of claim 9, where the microcontroller is operably connected to a central processing unit (CPU) and an I/O controller hub and at least two sets of RAM.

11. The apparatus of claim 1, the outgoing signal including one or more of, an inventory of add-on devices operably connected to the computing platform, information concerning an add-on device operably connected to the computing platform including state information, information concerning the computing platform status, information concerning an action initiated with respect to an add-on device, and information concerning an action initiated with respect to the computing platform.

12. The apparatus of claim 2,
where the device self diagnostic resides in an option ROM associated with the device,
where initiating a platform safe mode includes one or more of, booting the computing platform where devices not included in a known-good list are disabled, booting the computing platform with operating system settings based on information in the data store, and booting the computing platform with operating system settings based on a signal from the remote logic,
where booting the computing platform includes selectively initializing an add-on device operably connected to the computing platform based, at least in part, on information communicated to the computing platform by the apparatus,
where the add-on device is operably connected to the computing platform by one of, a PCI connection, an AGP connection, a PCI-E connection, a VGA connection, a DVI connection, and a USB connection,
the apparatus being operably connected to an always available network connection and an always available power source,
the data store being a flash memory,
where the first logic, the second logic, the third logic, and the fourth logic reside in a manageability engine logic in a microcontroller, the microcontroller being a member of a platform chipset,
where the microcontroller is operably connected to a CPU and an I/O controller hub and at least two sets of RAM, and
where the outgoing signal includes one or more of, an inventory of add-on devices operably connected to the computing platform, information concerning an add-on device operably connected to the computing platform including state information, information concerning the computing platform status, information concerning an action initiated with respect to an add-on device, and information concerning an action initiated with respect to the computing platform.

13. A method, comprising:
receiving, in a microcontroller, a control signal from a remote logic, the control signal to control execution of executable instructions stored in firmware in the microcontroller, the microcontroller being a member of a chipset for a computing platform, the microcontroller being operably connected to an always-on power supply and to an always-available memory;
selectively executing one or more of the executable instructions stored in firmware based, at least in part, on the control signal, where the executable instructions perform one or more of, establishing a platform safe mode for the computing platform, determining a state of an add-on device operably connected to the computing platform, communicating a conditional device initialization signal to the computing platform, and instructing an add-on device operably connected to the computing platform to perform a diagnostic; and
storing a value in the always-available memory, the value being associated with the execution of the executable instructions.

14. The method of claim 13, comprising:
maintaining a data store containing information regarding an add-on device operably connected to the computing platform, the information including the state of the device;
providing information from the data store to one or more of, a remote user, a local user, a remote logic, and a local logic; and
selectively taking an action based on information in the data store.

15. The method of claim 14, comprising:
notifying one or more of, a remote user, a local user, a remote logic, and a local logic, of information from the data store; and
recommending to one or more of, the remote user, the local user, the remote logic, and the local logic, an action to take based, at least in part, on information from the data store.
